(19) United States
(12) Patent Application Publication
(10) Pub. No.: US 2020/0234225 A1
(43) Pub. Date: Jul. 23, 2020

(54) PLAN REGISTRATION APPARATUS, PLAN REGISTRATION METHOD, AND RECORDING MEDIUM

(71) Applicant: CASIO COMPUTER CO., LTD., Tokyo (JP)

(72) Inventor: Toru SAKAI, Yokohama-shi (JP)

(73) Assignee: CASIO COMPUTER CO., LTD., Tokyo (JP)

(21) Appl. No.: 16/742,442

(22) Filed: Jan. 14, 2020

(30) Foreign Application Priority Data
Jan. 22, 2019 (JP) 2019-008306

(51) Int. Cl. G06Q 10/06; G06Q 10/10

(52) U.S. Cl. CPC G06Q 10/063116; G06Q 10/06312; G06Q 10/1093

(57) ABSTRACT

A plan registration apparatus includes a processor configured to execute plan registration processing of registering a plan to predetermined plan information on the basis of input information representing the plan, including settings related to participants selected from a plurality of persons to be managed, time zones, and establishment conditions, in which the plan registration processing performs, at registration of plans to the plan information, finalized registration as an established plan in a case where the establishment conditions for the plan are satisfied, and performs provisional registration as a provisional plan before establishment in a case where the establishment conditions of the plan are not satisfied, and cancels the provisional registration and performs the finalized registration for the plan in a case where the establishment conditions for the plan are satisfied after execution of the provisional registration of the plan.

### BACKGROUND

### 1. Technical Field

The present invention relates to a plan registration apparatus, a plan registration method, and a recording medium.

### 2. Related Art

There is conventionally known an information processing apparatus that is used as a schedule management apparatus that manages a schedule of a plurality of persons. In this information processing apparatus, for example, information regarding a plan that designates participants and a time zone is registered to the schedules of persons designated as participants, whereby the schedule of each of the persons is managed.

Conventionally, there is a technology of adjusting overlapping of plans when a time zone of a plan to be registered overlaps at least a part of the time zone of an existing plan in a participant's schedule. For example, JP 2009-187212 A discloses a technique of performing provisional registration of a plan to be added with its time zone changed so as not to overlap with the time zone of an existing plan, and then adjusting a conflict with the existing plan later. As another example, JP 2015-176398 A discloses a technology that, in a case where a plan that overlaps with an existing plan is provisionally registered in accordance with a user instruction, a selection result of whether to participate can be obtained from a participant in the plan under provisional registration and an instruction as to whether to finalize or delete the plan under provisional registration is received while presenting the selection result to the user.

However, in the registration of a plan, there is a case where non-overlapping of a plan with a time zone of an existing plan on the schedules of all the participants would not necessarily be an establishment condition for the plan. For example, there is a case where participation of a specific person among the participants is an establishment condition while the participation of other persons is optional, or a case where the number of participants is an establishment condition. Adjusting the plan uniformly using the above-described conventional technology in the case of registering such a plan might cause an unnecessary alteration of a time zone for the registered plan, or deletion of a plan regardless of availability of the plan.

As described above, the conventional technology has difficulty in flexibly adjusting a plan.

### SUMMARY

In order to achieve the above-described problem, a plan registration apparatus of the present invention includes a processor configured to execute plan registration processing of registering a plan to predetermined plan information on the basis of input information representing the plan, including settings related to participants selected from a plurality of persons to be managed, time zones, and establishment conditions, in which the plan registration processing performs, at registration of plans to the plan information, finalized registration as an established plan in a case where the establishment conditions for the plan are satisfied, and performs provisional registration as a provisional plan before establishment in a case where the establishment conditions of the plan are not satisfied, and cancels the provisional registration and performs the finalized registration for the plan in a case where the establishment conditions for the plan are satisfied after execution of the provisional registration of the plan.

### BRIEF DESCRIPTION OF THE DRAWINGS

FIG. 1 is a diagram illustrating a schematic configuration of a schedule management system;

FIG. 2 is a block diagram illustrating a functional configuration of a schedule management apparatus;

FIG. 3 is a block diagram illustrating a functional configuration of a terminal device;

FIG. 4 is a diagram illustrating a structure of data used for schedule management by a schedule management apparatus;

FIG. 5 is a diagram illustrating an example of content of individual plan data;

FIG. 6 is a view illustrating an example of content of individual schedule data;

FIG. 7 is a view illustrating an example of a schedule board;

FIG. 8 is a diagram illustrating a data state when individual plan data related to a meeting is added from the state of FIG. 4;

FIG. 9 is a view illustrating content of individual plan data related to the meeting;

FIG. 10 is a diagram illustrating content after updating each of pieces of data according to the addition of the individual plan data related to the meeting;

FIG. 11 is a view illustrating an example of a schedule board of a user in a state where provisional registration of the meeting has been performed;

FIG. 12 is a diagram illustrating a state of data after the user is deleted from participants in another meeting;

FIG. 13 is a view illustrating an example of a schedule board of the user in a state where finalized registration of the meeting has been performed;

FIG. 14 is a view illustrating an example of content of timer management data used for final establishment confirmation;

FIG. 15 is a view illustrating an example of a schedule board in a state where exclusion processing of the meeting has been performed;

FIG. 16 is a view illustrating an example of content of a schedule board that displays schedules of a plurality of users in a comparable manner;

FIG. 17 is a view illustrating a schedule board in a state where finalized registration of the meeting is performed;

FIG. 18 is a flowchart illustrating a control procedure of new plan registration processing;

FIG. 19 is a flowchart illustrating a control procedure of schedule data plan addition processing;

FIG. 20 is a flowchart illustrating a control procedure of plan establishment determination processing;

FIG. 21 is a flowchart illustrating a control procedure of plan edit processing;

FIG. 22 is a flowchart illustrating a control procedure of schedule data update processing; and

FIG. 23 is a flowchart illustrating a control procedure of final establishment confirmation processing.

### DETAILED DESCRIPTION

Hereinafter, embodiments related to a plan registration apparatus, a plan registration method, and a recording medium of the present invention will be described below with reference to the drawings.

<Configuration of Schedule Management System>

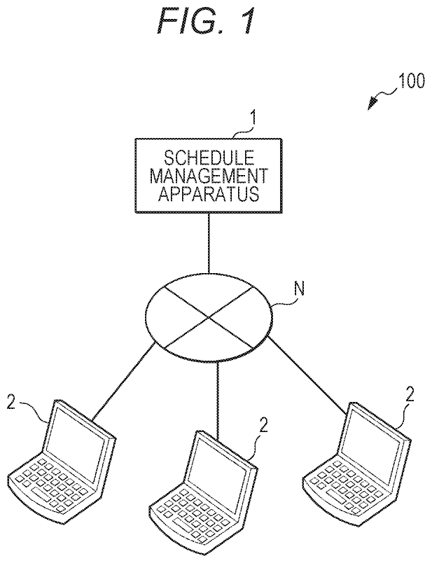

FIG. 1 is a diagram illustrating a schematic configuration of a schedule management system 100 according to the present embodiment.

The schedule management system 100 includes a schedule management apparatus 1 as a plan registration apparatus (information processing apparatus) and a terminal device 2 connected to the schedule management apparatus 1 via a communication network N.

The schedule management apparatus 1 is a server apparatus that stores and manages information related to a schedule for a plurality of persons to be managed (here, a plurality of users of the schedule management system 100) and performs predetermined processing on the information and transmits a result to the terminal device 2.

In the present embodiment, information regarding a plan (for example, a meeting or an event) including settings related to participants, time zones, and establishment conditions is stored and managed as information related to a schedule.

In the schedule management apparatus 1, a plan can be adjusted in consideration of plan establishment conditions. Plan adjustment methods will be described in detail below.

The terminal device 2 is a terminal device used by a user of the schedule management system 100, for example. Examples of the terminal device 2 include a notebook personal computer (PC), a desktop PC, a smartphone, a tablet PC, a mobile phone, and Personal Digital Assistant (PDA).

The terminal device 2 transmits information to the schedule management apparatus 1 in response to input operation from the user, and receives the information transmitted from the schedule management apparatus 1 and displays the information on a predetermined display screen.

An example of the communication network N can be the Internet, but may be another network such as a local area network (LAN).

A user of the schedule management system 100 browses and edits, on the terminal device 2, the information transmitted from the schedule management apparatus 1, thereby enabling confirmation and management of own schedule. Furthermore, the user can input information related to the schedule in the terminal device 2 and can transmit the information to the schedule management apparatus 1.

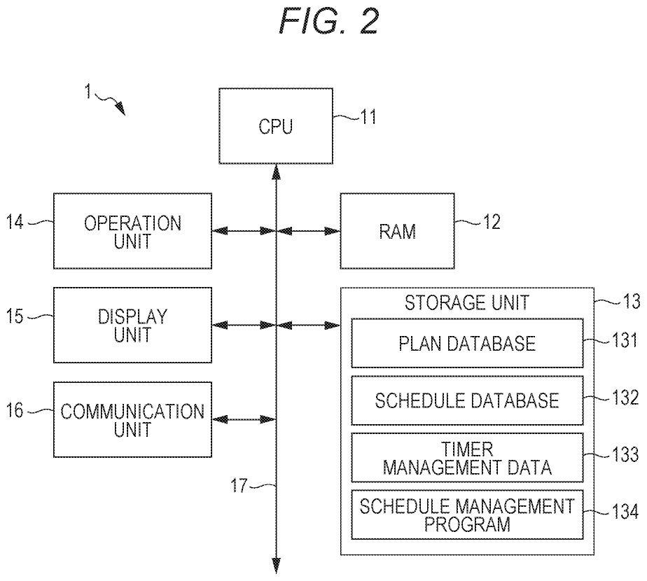

FIG. 2 is a block diagram illustrating a functional configuration of the schedule management apparatus 1.

The schedule management apparatus 1 includes a central processing unit (CPU) 11, a random access memory (RAM) 12, a storage unit 13, an operation unit 14, a display unit 15, a communication unit 16, a bus 17, or the like. Individual portions of the schedule management apparatus 1 are connected via the bus 17.

The CPU 11 is a processor that controls individual portions of the schedule management apparatus 1. The CPU 11 reads out a designated program from among the system programs and application programs stored in the storage unit 13, expands the program onto the RAM 12, and executes various types of processing according to the program. Execution of the processing allows the CPU 11 to function as a plan registration means, a schedule information processing means, a presentation means, and a display control means. Further, the CPU 11 executes plan registration processing, schedule information management processing, presentation processing, and display control processing.

The RAM 12 is, for example, a volatile memory and has a work area that temporarily stores various programs and data read by the CPU 11.

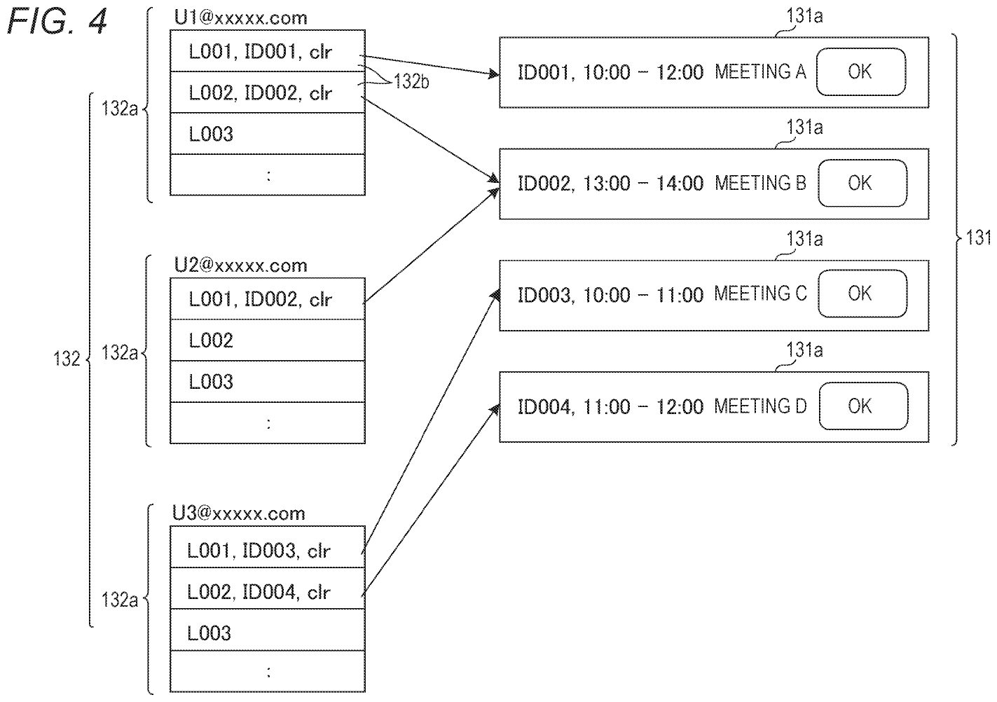

The storage unit 13 includes a storage device capable of writing and reading data, such as a hard disk drive (HDD) and a solid state drive (SSD), and stores files, or the like, containing various programs and data. The data stored in the storage unit 13 includes a plan database 131 (plan information) that is a database of individual plan data 131a (FIG. 4) regarding individual plans, a schedule database 132 (schedule information) that is a database of schedule data 132a (FIG. 6) regarding each of a plurality of users, and timer management data 133 used for timer processing to be described below. The storage unit 13 also stores a schedule management program 134 for causing the schedule management apparatus 1 to execute various types of processing related to schedule management.

The operation unit 14 includes a key input unit such as a keyboard and a pointing device such as a mouse, receives a key operation input and a position operation input from a user (operator), and outputs the operation information to the CPU 11.

The display unit 15 includes a liquid crystal display (LCD), an Electro Luminescence (EL) display, or the like, and performs various types of displays in accordance with display information instructed by the CPU 11.

The communication unit 16 includes a network card or the like, and transmits and receives data to and from the terminal device 2 and other devices connected via the communication network N.

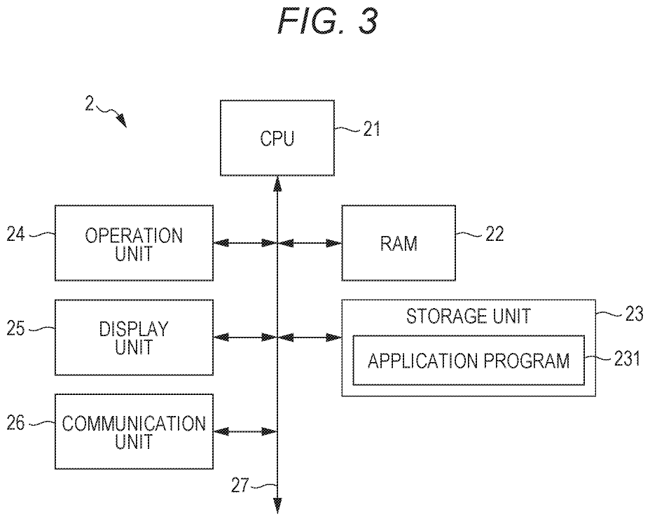

FIG. 3 is a block diagram illustrating a functional configuration of the terminal device 2.

The terminal device 2 includes a CPU 21, a RAM 22, a storage unit 23, an operation unit 24, a display unit 25, a communication unit 26, a bus 27, or the like. Individual portions of the terminal device 2 are connected via a bus 27.

The CPU 21 is a processor that controls individual portions of the terminal device 2. The CPU 21 reads a designated program from among the system programs and application programs stored in the storage unit 23, expands the program onto the RAM 22, and executes various types of processing according to the program.

The RAM 22 is a volatile memory, for example, and has a work area for temporarily storing various programs and data read by the CPU 21.

The storage unit 23 includes a storage device capable of writing and reading data, such as an HDD and an SSD, and stores files including various programs and data. The storage unit 23 stores an application program 231 for the user to check and edit own schedule.

The operation unit 24 includes a key input unit such as a keyboard and a pointing device such as a mouse, receives a key operation input and a position operation input from a user (operator), and outputs the operation information to the CPU 11.

The display unit 25 includes an LCD, an EL display, or the like, and performs various types of displays in accordance with display information instructed by the CPU 21.

The communication unit 26 includes a network card or the like, and transmits and receives data to and from the schedule management apparatus 1 and other devices connected via the communication network N.

<Schedule Management Method>

Next, a schedule management method in the schedule management system 100 will be described focusing on the operation of the schedule management apparatus 1.

FIG. 4 is a diagram illustrating a structure of data used for schedule management by the schedule management apparatus 1.

As illustrated in FIG. 4, the schedule management apparatus 1 manages schedules of a plurality of users by using the individual plan data 131a related to individual plans, included in the plan database 131, and using the schedule data 132a of each of users, included in the schedule database 132.

In the example of FIG. 4, the plan database 131 includes as plans four pieces of individual plan data 131a related to meetings A to D.

The schedule database 132 includes three pieces of schedule data 132a for three users U1 to U3. Each of users is specified by an email address in the schedule management apparatus 1, and the user is indicated by the email address in FIG. 4.

The schedule management apparatus 1 manages the schedules of the plurality of users by sequentially updating the content of the plan database 131 and the schedule database 132 in accordance with the addition of a plan or a change in the user's schedule.

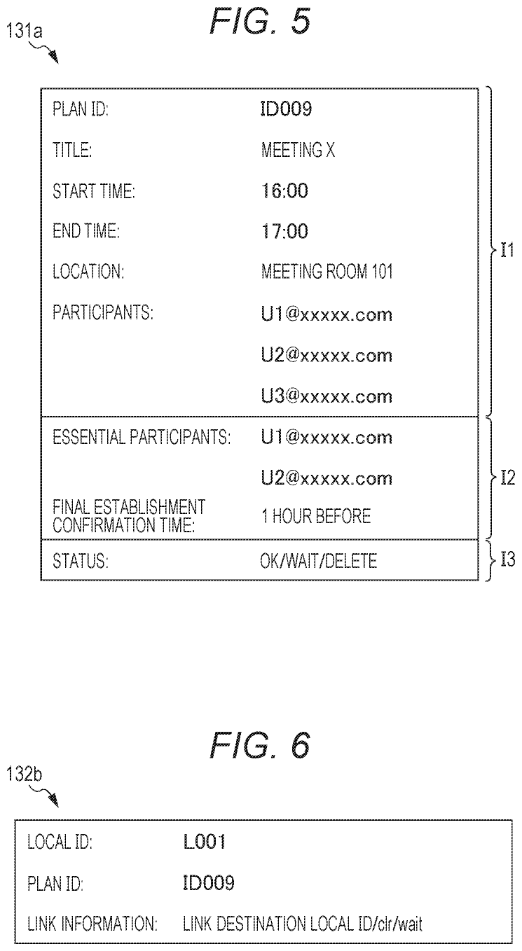

FIG. 5 is a diagram illustrating an example of content of the individual plan data 131a.

The individual plan data 131a includes: first information I1 containing “plan ID”, “title”, “start time”, “end time”, “location”, and “participant”; second information I2 containing “essential participant”, and “final establishment confirmation time”; and third information I3 containing “status”.

Among these pieces of information, the first information I1 is information input for all plans.

The second information I2 is information input for a plan for which the establishment condition is set. In other words, inputting each of items of the second information I2 enables setting of establishment conditions for a plan. In a case where the second information I2 is not input, the plan is treated as a plan with no establishment condition.

The third information I3 is a flag that is set by the CPU 11 in accordance with the satisfaction state of the establishment condition for a plan.

The individual plan data 131a will be added to the plan database 131 by user's predetermined input operation on the application program 231 on any of the terminal devices 2. The content of each of items except for “plan ID” and “status” will be input by the user who has registered the plan at the time of registration of the plan. This information input by the user corresponds to “input information” and is used for registration of a plan to the plan database 131.

Among the first information I1, “plan ID” is a character string attached to specify each of plans. Here, the combination of the character “ID” and a three-digit number is used. The present invention, however, is not limited to this, and it is possible to use any character string that can distinguish plans from each other.

“Title” is a character string representing the content of a plan input by the user who has registered the plan.

The “start time” and “end time” are pieces of information indicating a time zone of the plan.

“Location” is a character string representing a location of the plan.

“Participant” is a participant of the plan designated by the user who registered the plan. Participants are selected from a plurality of users to be managed in the schedule in the schedule management system 100.

Among the second information I2, “essential participant” is an essential participant designated by the user who has registered the plan, and is information indicating an establishment condition for the plan. That is, the plan is established when all users included in the “essential participants” will participate, and is not established when any of the “essential participants” will not participate. More specifically, in a case where the establishment condition is satisfied at the time of registration of the plan, finalized registration is performed as an established plan. In a case where the establishment condition is not satisfied, provisional registration is performed as a provisional plan before establishment. In addition, in a case where the establishment conditions for the plan are satisfied after the provisional registration is performed, the provisional registration of the plan will be canceled and the finalized registration will be performed. Operations related to provisional registration and finalized registration will be described in detail below.

“Final establishment confirmation time” indicates the end of the provisional registration acceptable period in which provisional registration can be maintained for the plan. Here, the time is designated using the relative time based on the meeting start time, but it may be designated as absolute time. In a case where provisional registration is maintained until the time designated in the “final establishment confirmation time”, it is determined whether the establishment condition is satisfied. When it is determined that the establishment condition is not satisfied, non-establishment processing is performed as a non-established plan for that meeting.

The “status” in the third information I3 is a flag that indicates a satisfaction state of an establishment condition for a plan. Specifically, “status” is set to any of “OK” indicating that the registration condition is satisfied and the finalized registration is completed, “WAIT” indicating that the establishment condition is not satisfied and the provisional registration is completed, and “DELETE” indicating that a state that the plan is not established (state of non-establishment).

FIG. 4 illustrates the content of the status at the right end portion of the rectangle representing each of pieces of individual plan data 131a. The four pieces of individual plan data 131a related to the meetings A to D in FIG. 4 are assumed to satisfy the establishment conditions. Accordingly, the status indicates “OK” in each of pieces of the individual plan data 131a.

Meanwhile, each of pieces of schedule data 132a of the schedule database 132 includes a plurality of pieces of individual schedule data 132b each corresponding to one plan, as illustrated in FIG. 4. Each of pieces of user's schedule data 132a includes individual schedule data 132b for a plan in which the user is designated as a participant. Specifically, when a plan (individual plan data 131a) is registered in the plan database 131, individual schedule data 132b corresponding to the plan is added to the schedule data 132a of the user designated as a participant in the plan. As a result, each of pieces of individual schedule data 132b corresponding to the plan in which the user is designated as a participant will be sequentially added to the schedule data 132a of each of users.

FIG. 6 is a view illustrating an example of content of individual schedule data 132b.

The individual schedule data 132b includes information of “local ID”, “plan ID”, and “link information”.

Among these, the “local ID” is a character string for specifying individual plans in the user's schedule data 132a. Here, the combination of the letter “L” and a three-digit number is used. The present invention, however, is not limited to this, and it is possible to use any character string that can distinguish plans from each other in the user's schedule data 132a.

The “plan ID” represents a plan specified by the individual schedule data 132b, and corresponds to the “plan ID” in the individual plan data 131a. That is, with attachment of “plan ID”, a plan of the individual schedule data 132b is associated with the plan of any of pieces of the individual plan data 131a. In other words, the “plan ID” is information for associating the user's schedule data 132a with the plan registered in the plan database 131. The example of FIG. 6 indicates that the plan with the local ID “L001” in the schedule of a certain user is a plan specified by plan ID “ID009” in the plan database 131, that is, “meeting X” of FIG. 5.

“Link information” is information regarding a time zone overlapping state of the individual schedule data 132b with respect to the other individual schedule data 132b, and can be one of “link destination local ID”, “clr”, or “wait”.

In a case where a time zone of a first plan overlaps with at least a part of a time zone of an existing second plan when the individual schedule data 132b related to the first plan is to be added to the schedule data 132a, the local ID of the individual schedule data 132b related to the first plan is set in the “link information” of the individual schedule data 132b related to the second plan.

In this case, “wait” is set in the “link information” of the individual schedule data 132b related to the first plan. The plan with the setting of “wait” is a plan having time zone overlapping with the existing plan, and there is a prospect of non-participation of the user in the plan. Therefore, the link information of “wait” is information indicating a plan in a waiting state for which there is a prospect of non-participation of the user.

In a case where the plan of the individual schedule data 132b has no time zone overlapping with any other plan of the individual schedule data 132b, “clr” is set as “link information”.

In the schedule data 132a of the user U1 in the example of FIG. 4, each of the pieces of individual schedule data 132b with the local IDs “L001” and “L002” is associated with each of the plan ID “ID001 (meeting A)” and the plan ID “ID002 (meeting B)”, respectively. That is, the meeting A and the meeting B are determined as plans in the schedule of the user U1. In addition, since there is no time zone overlapping between the meeting A and the meeting B, the link information is “clr” in each of the pieces of individual schedule data 132b.

Similarly, in the schedule data 132a of the user U2, the plan with the plan ID “ID002 (meeting B)” is associated with the individual schedule data 132b with the local ID “L001”.

Moreover, in the schedule data 132a of the user U3, each of the pieces of individual schedule data 132b with the local IDs “L001” and “L002” is associated with each of the plan ID “ID003 (meeting C)” and the plan ID “ID004 (meeting D)”, respectively.

With execution of the application program 231 in the terminal device 2, the user can confirm the schedule based on own schedule data 132a. After execution of the application program 231, a transmission request for the schedule data 132a is transmitted to the schedule management apparatus 1. In response to this request, the latest schedule data 132a associated with the user will be transmitted from the schedule management apparatus 1 to the terminal device 2. In the terminal device 2, a schedule board 30 indicating user schedules is displayed on the display unit 25 on the basis of content of the schedule data 132a.

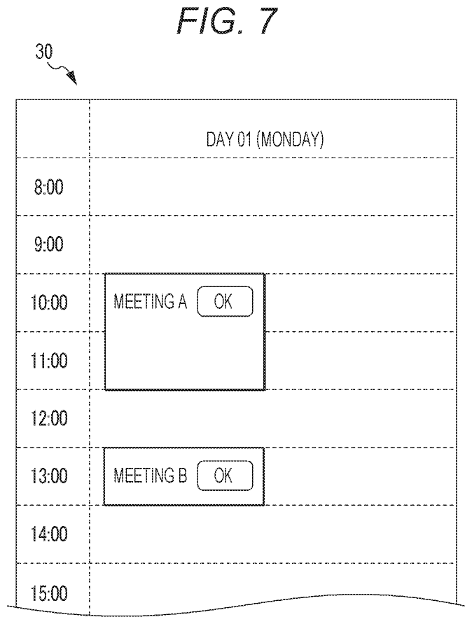

FIG. 7 is a view illustrating an example of the schedule board 30.

The schedule board 30 displays plans included in the schedule data 132a in the time schedule of the date designated by the user. While FIG. 7 displays the time schedule for a specific day, it is allowable to display a time schedule for two days or more as a list.

FIG. 7 displays the schedule board 30 generated on the basis of the schedule data 132a of the user U1 in FIG. 4. The schedule board 30 of the user U1 displays the meeting A (10:00 to 12:00) with the local ID “L001” and the meeting B (13:00 to 14:00) with the local ID “L002”. In addition, the status (here, “OK”) is also displayed for each of the plans.

With such a screen, the user U1 can confirm the schedule of the day.

<Provisional Registration and Finalized Registration of Plans>

Next, adjustment operation for plans using processing of the provisional registration and finalized registration of a plan will be described with an exemplary case where the meeting E (plan ID: ID005) is newly added to the state of FIG. 4.

In a case where a plan is to be added, individual plan data 131a related to the new plan is first added to the plan database 131.

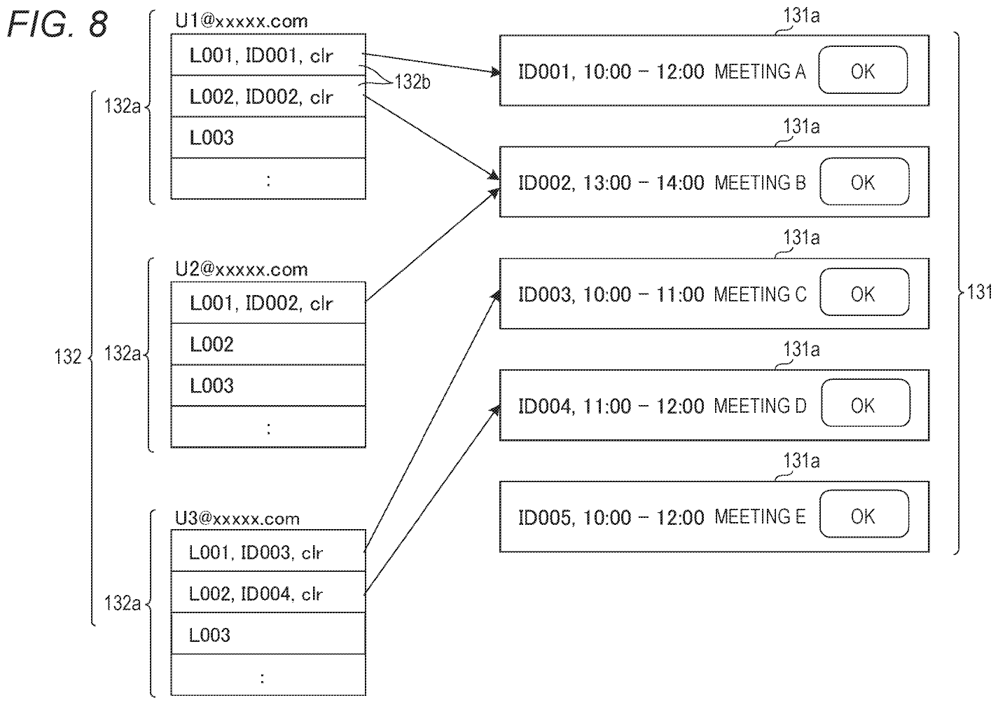

FIG. 8 is a diagram illustrating a data state when individual plan data 131a related to the meeting E is added to the state of FIG. 4.

FIG. 8 illustrates a state after update of adding the individual plan data 131a related to the meeting E to the plan database 131 is performed, and before the updated content is reflected to the schedule database 132. At this stage, the status of the individual plan data 131a related to the meeting E is provisionally set to “OK”.

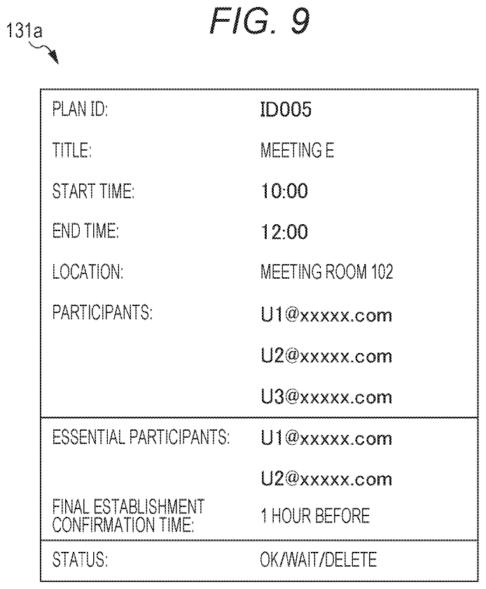

FIG. 9 is a view illustrating content of the individual plan data 131a related to the meeting E.

The meeting E has a plan ID “ID005”. In addition, the time zone is set to “10:00-12:00”. Accordingly, the meeting E has time zone overlapping with the meeting A of FIG. 4.

Furthermore, the users U1 to U3 are designated as “participants”, and the users U1 and U2 among these are designated as “essential participants”.

The “final establishment confirmation time” is set one hour before the start time.

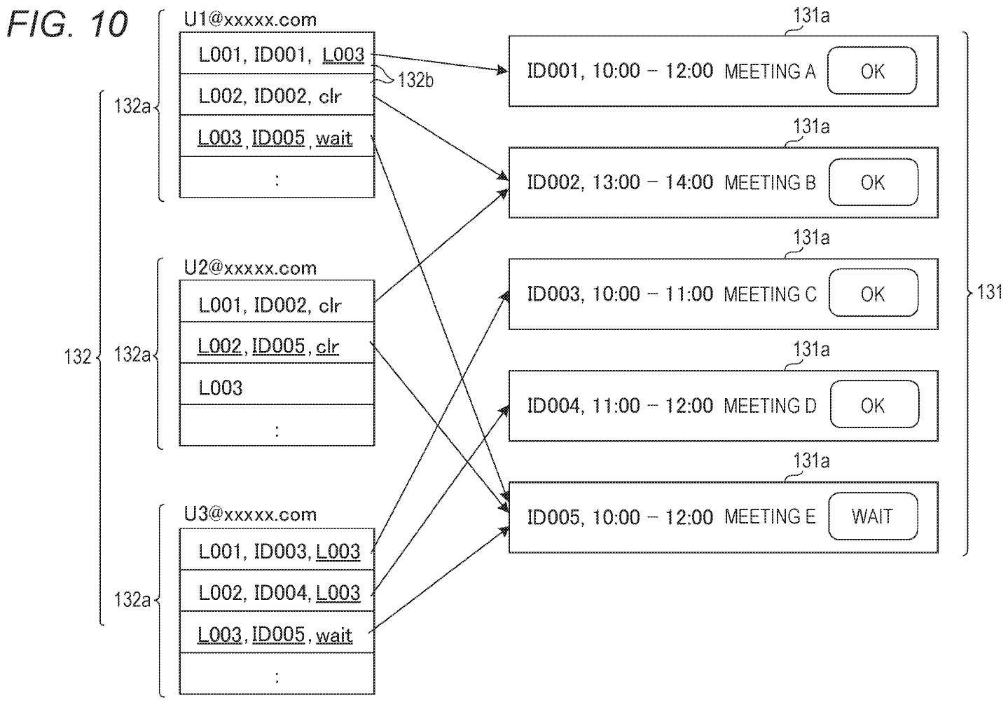

FIG. 10 is a diagram illustrating content after updating each of pieces of data according to the addition of the individual plan data 131a related to the meeting E.

After the individual plan data 131a related to the meeting E is added to the plan database 131, the individual schedule data 132b corresponding to the meeting E is first added to the schedule data 132a of the users U1 to U3 designated as the participants in the meeting E.

Here, the individual schedule data 132b with the local ID “L003” and the plan ID “ID005” is added to the schedule data 132a of the user U1, then, the individual schedule data 132b with the local ID “L002” and the plan ID “ID005” is added to the schedule data 132a of the user U2, and then, the individual schedule data 132b with the local ID “L003” and the plan ID “ID005” is added to the schedule data 132a of the user U3.

Next, it is determined, for each of users, whether the time zone of the added plan overlaps at least partly with the time zone of the existing plan, and then, “link information” in each of pieces of individual schedule data 132b is updated in accordance with the determination result.

For example, in the schedule data 132a of the user U1, the added meeting E has time zone overlapping with the existing meeting A (with local ID “L001” and plan ID “ID001”). Therefore, in the individual schedule data 132b with the local ID “L001” corresponding to the meeting A, the local ID “L003” of the individual schedule data 132b corresponding to the meeting E is set as the link information. Accordingly, in the individual schedule data 132b with the local ID “L003” corresponding to the meeting E, “wait” is set as the link information because of time zone overlapping with the existing meeting A.

Since there is no plan having time zone overlapping with the meeting E in the schedule data 132a of the user U2, the link information is set to “clr” in the individual schedule data 132b with the local ID “ID002” corresponding to the meeting E.

In the schedule data 132a of the user U3, the added meeting E has time zone overlapping with the existing meeting C (with local ID “L001” and plan ID “ID003”) and the meeting D (with local ID “L002” and plan ID “ID004”). Therefore, in the individual schedule data 132b with the local IDs “L001” and “L002” corresponding to the meetings C and D, the local ID “L003” of the individual schedule data 132b corresponding to the meeting E is set as the link information. Accordingly, in the individual schedule data 132b with the local ID “L003” corresponding to the meeting E, the link information is set to “wait” because of time zone overlapping with the existing meetings C and D.

In this manner, after the schedule data 132a of each of users is updated, the establishment condition is determined next for the individual plan data 131a related to the added meeting E. That is, it is determined whether there is a prospect of non-participation of the users U1 and U2 with reference to the schedule data 132a for the users U1 and U2 designated as essential participants. Specifically, in a case where the link information of the individual schedule data 132b corresponding to the meeting E is set to “wait” in the schedule data 132a of a user as an essential participant, it is determined that there is a prospect of non-participation of the user. In contrast, in a case where “link destination local ID” is set in the link information, or where the link information is set to “clr”, it is determined that there is a prospect of participation of the user. In a case where there is a prospect of non-participation of at least one user out of the essential participants in the meeting E, it is determined that the establishment conditions for the plan are not satisfied, and then, the status of the individual plan data 131a of the meeting E will be changed to “WAIT”. In contrast, in a case where there is a prospect of participation of all the essential participants, it is determined that the establishment conditions for the plan are satisfied, and then the status of the individual plan data 131a of the meeting E will be maintained at “OK”.

As a result of the determination of the establishment conditions for a plan, the operation of determining that the establishment condition is not satisfied and changing the status to “WAIT” corresponds to the provisional registration of the plan. Furthermore, the operation of determining that the establishment condition is satisfied and maintaining the status “OK” corresponds to the finalized registration of the plan.

In the example of FIG. 10, the link information of the individual schedule data 132b corresponding to the meeting E is set to “wait” for the user U1 among the essential participants of the meeting E. Accordingly, it is determined that the establishment condition for the plan is not satisfied and then, the status of the individual plan data 131a of the meeting E is changed to “WAIT”. In other words, provisional registration will be performed for the meeting E.

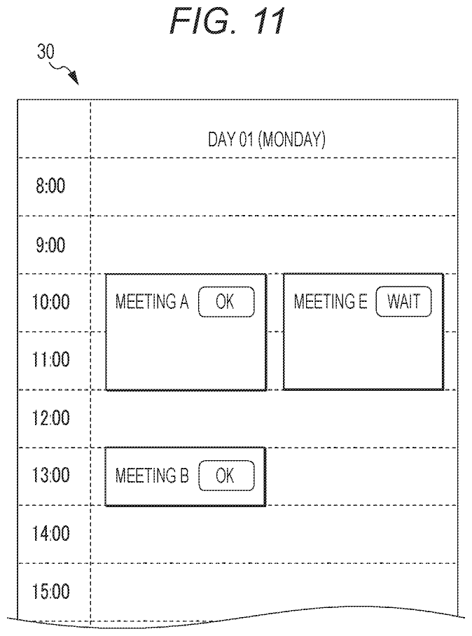

FIG. 11 is a view illustrating an example of the schedule board 30 of the user U1 in a state where provisional registration of the meeting E has been performed.

In this schedule board 30, the meeting E is added from the schedule board 30 of FIG. 7, and “WAIT” indicating the provisional registration state is displayed as the status of the meeting E. With this display, the user can confirm that the meeting A and the meeting B are established, and that the meeting E is a provisional plan before establishment.

<Determination of Establishment Condition After Provisional Registration, and Finalized Registration According to Result of Determination>

Next, operation in a case where the establishment conditions for the plan for which provisional registration has been completed are satisfied will be described. In the present embodiment, after provisional registration of a plan is completed, the establishment condition is determined again at a predetermined timing. In a case where it is determined that the establishment condition is satisfied, the provisional registration of the plan is canceled and the finalized registration will be performed.

The timing of re-determination of the establishment condition is not particularly limited. The timing can be determined as a timing when setting (content of individual plan data 131a) of a plan has been changed or deletion of the plan has been performed, for the plan for which provisional registration has been performed (meeting E in the above example) or other plans waiting for the decision about the plan (meetings A, C, and D in the above example).

Here, a case where the user U1 has been deleted from the participants in the meeting A from the state of FIG. 10 will be described as an example.

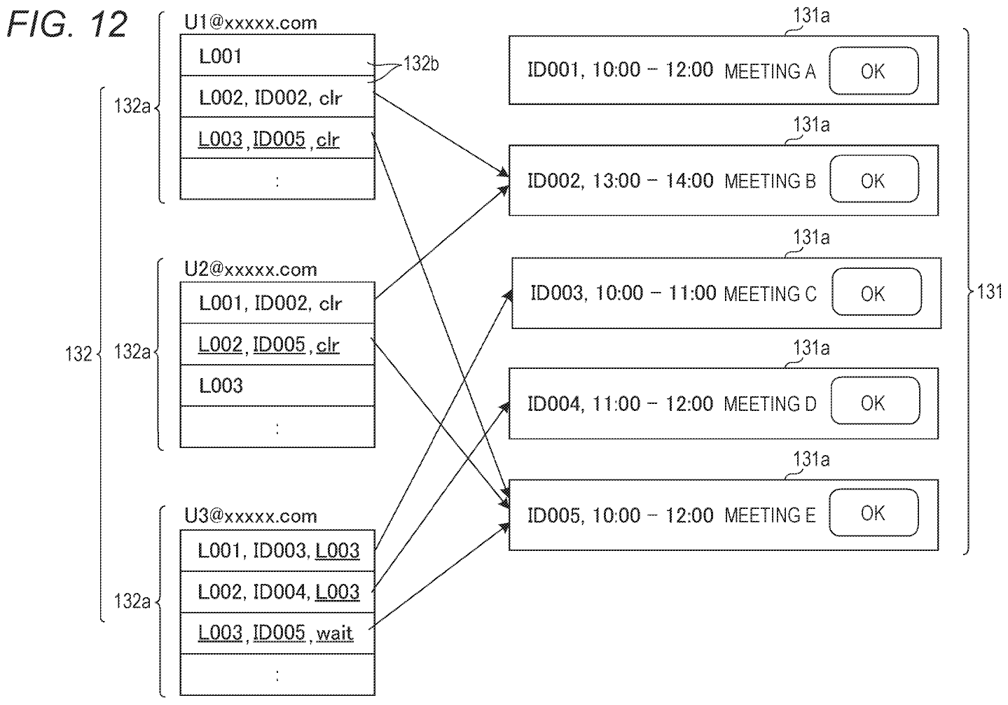

FIG. 12 is a diagram illustrating a state of data after the user U1 has been deleted from participants in the meeting A.

Edition of a plan (for example, change in a participant in a meeting or deletion of a meeting) is executed by a user who has registered the plan when the user performs predetermined input operation on the application program 231 on the terminal device 2. In response to this, processing of changing the setting of the individual plan data 131a or deleting the individual plan data 131a is performed in the plan database 131. After setting change or deletion is performed for the individual plan data 131a in the plan database 131, the corresponding individual schedule data 132b for the data will be updated in the schedule database 132.

In the example of FIG. 12, the individual schedule data 132b with the local ID “L001” of the user U1 will be deleted in response to the deletion of the user U1 from the participants in the individual plan data 131a for the meeting A. For convenience of explanation, only the local ID of the deleted individual schedule data 132b is left in FIG. 12. However, the entire individual schedule data 132b including the local ID may be deleted.

Since the individual schedule data 132b related to the meeting A is deleted in the schedule data 132a of the user U1, there is no remaining plan having time zone overlapping with the meeting E. Accordingly, the link information is changed to “clr” in the individual schedule data 132b of the local ID “L003” corresponding to the meeting E.

Note that specifically, the link information changed is executed by processing including first tentatively deleting the individual schedule data 132b set as the link destination local ID in the deleted individual schedule data 132b, adding it again, and then confirming time zone overlapping with other individual schedule data 132b. The detailed flow of this processing will be described below.

At a timing of completion of the update of the schedule data 132a in this manner, the establishment condition is determined again for each of pieces of individual plan data 131a in the plan database 131. Here, the link information of the individual schedule data 132b corresponding to the meeting E is set to “clr” in the schedule data 132a of the users U1 and U2 who are essential participants in the individual plan data 131a of the meeting E. Therefore, it is determined that the establishment conditions for the meeting E are satisfied, and the status of the individual plan data 131a of the meeting E will be changed to “OK”. That is, the provisional registration of the meeting E is canceled, and the finalized registration will be performed.

In the state of FIG. 12, the link information of the individual schedule data 132b related to the meeting E is still “wait” in the schedule data 132a of the user U3. Regardless of this setting, the provisional registration of the meeting E is canceled and the finalized registration will be performed. This is because the user U3 is not designated as an essential participant in the meeting E.

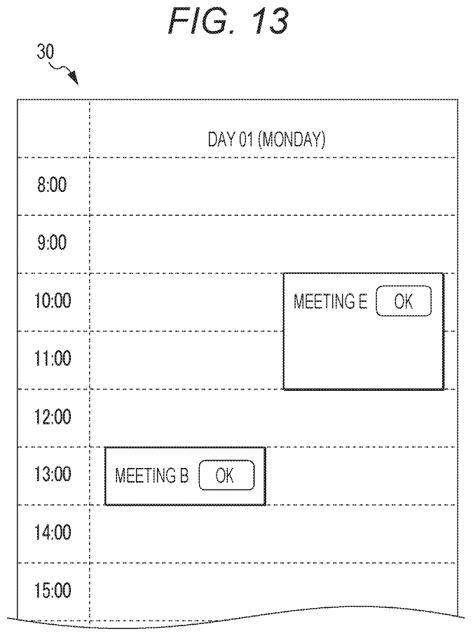

FIG. 13 is a view illustrating an example of the schedule board 30 of the user U1 in a state where finalized registration of the meeting E has been performed.

In the schedule board 30, the meeting A has been deleted from the schedule board 30 in FIG. 11, and the meeting E has been added. In addition, “OK” indicating the finalized registration state is displayed as the status of the meeting E.

Note that the timing for re-determination of the establishment condition may include the timing at which user's intention of non-participation in the plan (intention of canceling the plan) is presented. The presentation of user's intention of non-participation is received when the user performs predetermined input operation on the application program 231 on the terminal device 2. In a case where the presentation of the user's intention of non-participation in the plan is received, the individual schedule data 132b related to the plan will be deleted from the user's schedule data 132a. The following processing is similar to the processing described above.

<Final Establishment Confirmation and Non-Establishment Processing>

Next, the final establishment confirmation and non-establishment processing for a plan will be described.

The plan under provisional registration is a plan that might shift to the finalized registration when the establishment conditions are satisfied. However, there is a problem that shifting to the finalized registration immediately before the start time of a plan to finalize execution of the plan would cause insufficient notification to the participants, leading to confusion.

To handle this problem, the present embodiment allows the final establishment confirmation to be performed for a plan for which provisional registration is maintained at a stage of predetermined time before the start time of the plan. In a case where the establishment condition is not satisfied at that point, predetermined non-establishment processing will be performed as a non-established plan. This processing can suppress occurrence of the above problem.

The timing for performing the final establishment confirmation is set by the “final establishment confirmation time” of the individual plan data 131a. Furthermore, the “final establishment confirmation time” of each of pieces of the individual plan data 131a is collected and managed in the timer management data 133.

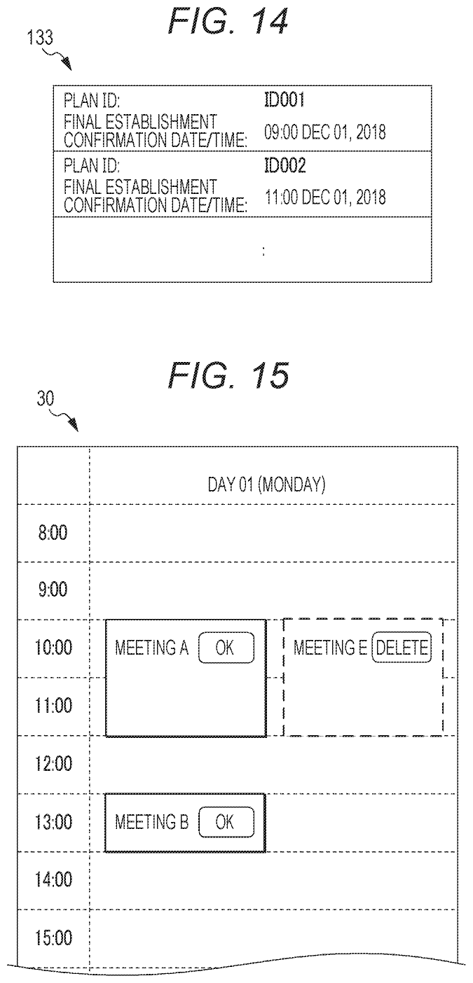

FIG. 14 is a view illustrating an example of content of the timer management data 133 used for final establishment confirmation. The timer management data 133 includes “plan ID” and “final establishment confirmation time” for each of plans to be managed.

The “plan ID” is a plan ID of plan to which “final establishment confirmation time” is set.

“Final establishment confirmation date/time” is obtained by converting the “final establishment confirmation time” of the individual plan data 131a into absolute time, and indicates the starting time of the non-establishment processing.

When any of the final establishment confirmation dates/times of the timer management data 133 arrives, final establishment confirmation is performed for the plan with the corresponding plan ID, and then, non-establishment processing is executed in accordance with the result. In the non-establishment processing, the status in the individual plan data 131a will be changed to “DELETE”.

In a case where the status of the individual plan data 131a has been changed to “DELETE”, exclusion processing for excluding data from the schedule of each of users is performed in the schedule database 132. The content of the exclusion processing is not particularly limited, but the simplest processing can be processing of deleting the individual schedule data 132b related to the corresponding plan. Alternatively, a flag indicating that the status has shifted to the “DELETE” status may be provided to perform a predetermined display indicating that the plan is a non-established plan on the schedule board 30. For example, as illustrated in FIG. 15, the status of “DELETE” may be explicitly indicated and the frame of the plan may be illustrated in a broken line. Alternatively, it is also allowable to display that the plan is a non-established plan by coloring a predetermined frame in a predetermined color or displaying characters in a pale color.

<Schedule Adjustment Using Schedule Board>

Next, a schedule adjustment method using a schedule board 31 (schedule screen) that displays schedules of a plurality of users in a comparable manner will be described.

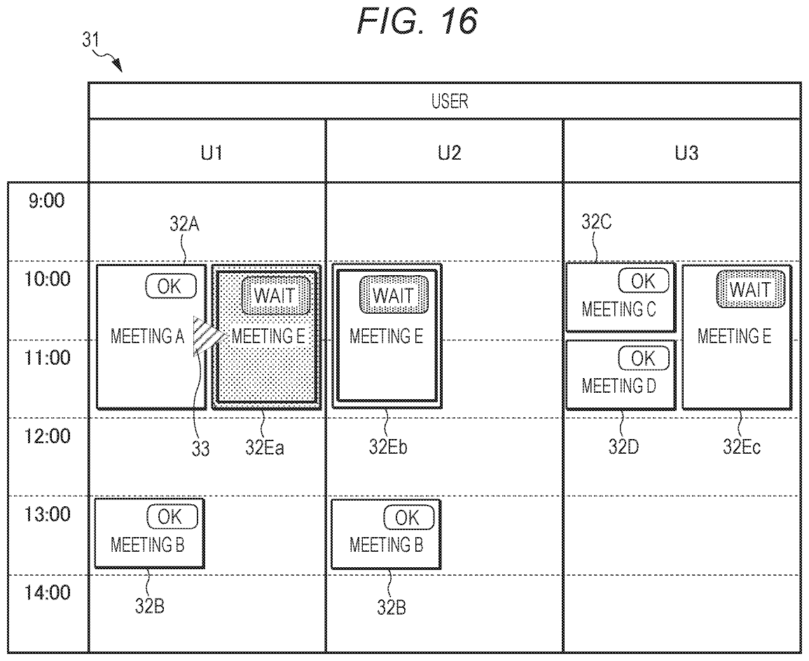

FIG. 16 is a view illustrating an example of content of the schedule board 31 that displays schedules of a plurality of users in a comparable manner.

The schedule board 31 is displayed on the display unit 25 by execution of the application program 231 on the terminal device 2. The schedule board 31 may be displayed instead of the user's personal schedule board 30 described above, or may be displayed together with the schedule board 30.

The schedule board 31 displays the schedules of two or more participants (here, users U1 to U3) of the plans (meetings A to E in FIG. 16) in a comparable manner. Specifically, the schedules of the users U1 to U3 are displayed in a horizontal direction with respect to a common time axis in the vertical direction. The schedule board 31 of FIG. 16 displays the schedules of individual users in the state of FIG. 10, that is, a state where the finalized registration of the meetings A to D and the provisional registration of the meeting E have been completed.

Specifically, schedule blocks 32Ea to 32Ec indicating the meeting E are displayed in the schedules of the users U1 to U3, respectively. In the schedule of the user U1, the schedule block 32A of the meeting A is displayed in the time zone overlapping with the meeting E. In the schedule of the user U3, the schedule blocks 32C and 32D of the meetings C and D are respectively displayed in a time zone overlapping with the meeting E. Each of the schedule of the users U1 and U2 displays a schedule block 32B of the meeting B having no time zone overlapping with other meetings.

Among these, the schedule blocks 32Ea to 32Ec of the meeting E indicate that the provisional registration has been completed by a “WAIT” status display attached in the shaded rectangle on the upper right. A mode with the “WAIT” status display corresponds to a first mode.

In contrast, the schedule blocks 32A to 32D of the meetings A to D indicate that finalized registration has been completed by an “OK” status display attached in the white rectangle on the upper right. A mode with the “OK” status display corresponds to a second mode.

Note that the first mode and the second mode are not limited to the modes illustrated in FIG. 16. The modes may be any mode as long as the user can distinguish the plans displayed in the first mode and the second mode. For example, the first mode and the second mode may be displayed in mutually different thickness or color of the outer frame of the schedule block, the color of the region inside the outer frame, the font of characters, or the like. The first mode and the second mode may be made distinguishable with different symbols and signs attached to the schedule blocks.

In the schedule board 31, the outer frame of the schedule block of the plan is displayed with a double line in the schedule of the essential participant of the plan. In the example of FIG. 16, the outer frames of the schedule blocks 32Ea and 32Eb are double lines respectively in the schedules of the users U1 and U2, indicating that the users U1 and U2 are essential participants in the meeting E.

In the schedule board 31, schedule blocks of a plan having link information setting of “wait” in the individual schedule data 132b are displayed in color. In the example of FIG. 16, the meeting E of the user U1 has a time zone overlapping with the time zone of the meeting A, and thus, the link information is set to “wait”. Accordingly, the schedule block 32Ea is displayed in color. With this configuration, focusing on the colored schedule block makes it possible to intuitively grasp the user (here, the user U1) being a factor of non-satisfaction of establishment conditions (that is, the factor of provisional registration).

Furthermore, a triangular overlapping relationship display mark 33 is displayed between a plan having link information setting of “wait” and another plan having a time zone overlapping with the plan. With this overlapping relationship display mark 33, it is possible to easily grasp which plan affects the setting of “wait” in the colored schedule block. In the example of FIG. 16, the factor of setting of “wait” in the meeting E of the schedule block 32Ea in the schedule of the user U1 is the meeting A of the schedule block 32A. Accordingly, the overlapping relationship display mark 33 is displayed between the schedule block 32A and the schedule block 32Ea.

With the display of such a schedule board, the user can easily grasp the types of schedule adjustment necessary to shift the plan from the provisional registration to the finalized registration. In the example of FIG. 16, the meeting A of the schedule block 32A in the schedule of the user U1 has the overlapping relationship display mark 33 between the schedule block 32A and the colored schedule block 32E, making it possible to grasp that the meeting A is a factor of non-satisfaction of the establishment condition of the meeting E.

For example, with adjustments such as cancelling, on the user U1, of attendance of the meeting A, or deleting the user U1 from participants in the meeting A, to be performed in the state of FIG. 16, it would be possible to satisfy the establishment conditions for the meeting E, enabling shifting the meeting E to finalized registration.

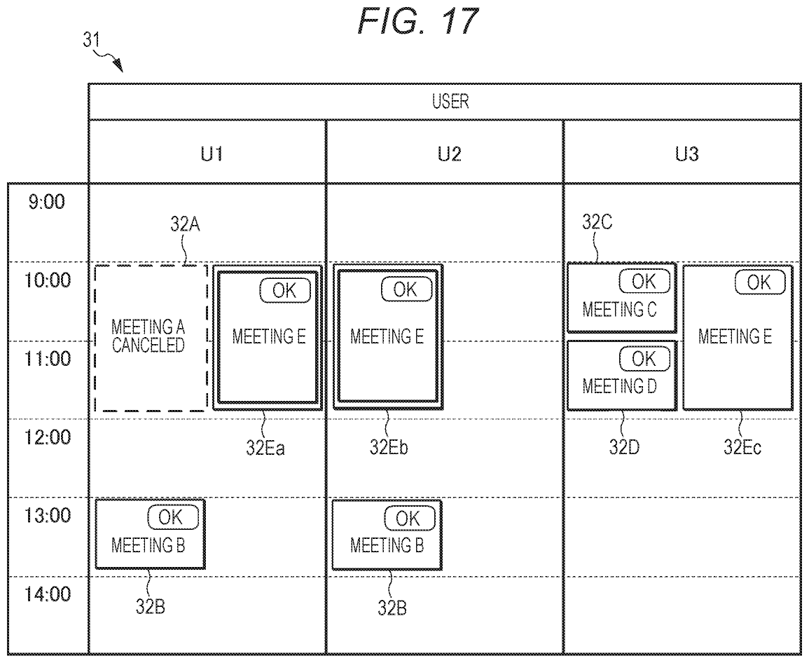

FIG. 17 is a view illustrating the schedule board 31 in a state where finalized registration of the meeting E is performed. The content of the schedule board 31 in FIG. 17 corresponds to the state in FIG. 12, that is, the state in which the meetings A to E are all under finalized registration.

In FIG. 17, since the meeting E is under finalized registration, the schedule blocks 32Ea to 32Ec are displayed in the second mode including the “OK” status display.

In addition, in the individual schedule data 132b of the user U1, the coloring of the schedule block 32Ea is canceled because the link information of the meeting E is changed to “clr”.

Furthermore, in response to the cancel operation for the meeting A on the user U1, the frame of the schedule block 32A of the meeting A has been changed to a broken line, indicating that the meeting has been canceled.

In this manner, with the use of the schedule board 31 capable of comparing the schedules of a plurality of users, it is possible to perform schedule adjustment for shifting the plan from provisional registration to finalized registration in a method easy to grasp visually and intuitively.

Although FIG. 16 is an example of performing schedule adjustment by displaying, on the schedule board 31, schedules of individual users in a partial time zone of the day. However, the present invention is not limited to this. For example, the schedule board 31 may be displayed so that individual user's weekly schedules can be mutually compared in a weekly calendar format, or displayed so that monthly schedules can be mutually compared in a monthly calendar format.

<Control Procedures for Various Types of Processing Related to Schedule Management>

Next, a control procedure by the CPU 11 for various types of processing executed at the above-described schedule management operation will be described. The various types of processing include new plan registration processing executed to newly add a plan, plan edit processing executed to edit an existing plan, and final establishment confirmation processing for performing final establishment confirmation. Hereinafter, individual processing will be described in order.

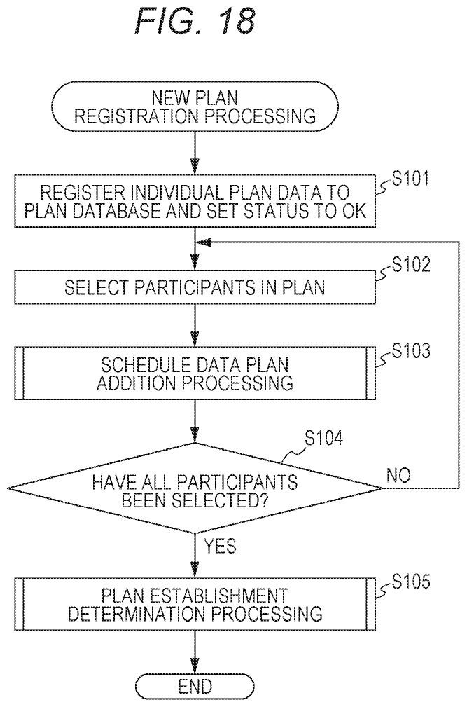

FIG. 18 is a flowchart illustrating a control procedure, executed by the CPU 11, of the new plan registration processing.

The new plan registration processing is started in a case where predetermined input operation for registering a plan has been performed by a user on the application program 231 in any of the terminal devices 2 and information related to the addition of the plan has been transmitted from the terminal device 2 and received by the schedule management apparatus 1.

When the new plan registration processing is started, the CPU 11 adds the individual plan data 131a related to the plan to be registered to the plan database 131 on the basis of the received information, and sets the status to “OK” (step S101).

The CPU 11 selects one user designated as a participant of the plan (step S102), and executes “schedule data plan addition processing” to be described below in order to add a plan to the schedule data 132a of the user (step S103).

The CPU 11 determines whether all participants of the plan have been selected (step S104). In a case where it is determined that there are unselected participants (“NO” in step S104), the processing returns to step S102.

In a case where it is determined that all the participants in the plan have been selected (“YES” in step S104), the CPU 11 executes “plan establishment determination processing” to be described below in order to determine whether the establishment conditions for the plan are satisfied (step S105).

After completion of the processing of step S105, the CPU 11 finishes the new plan registration processing.

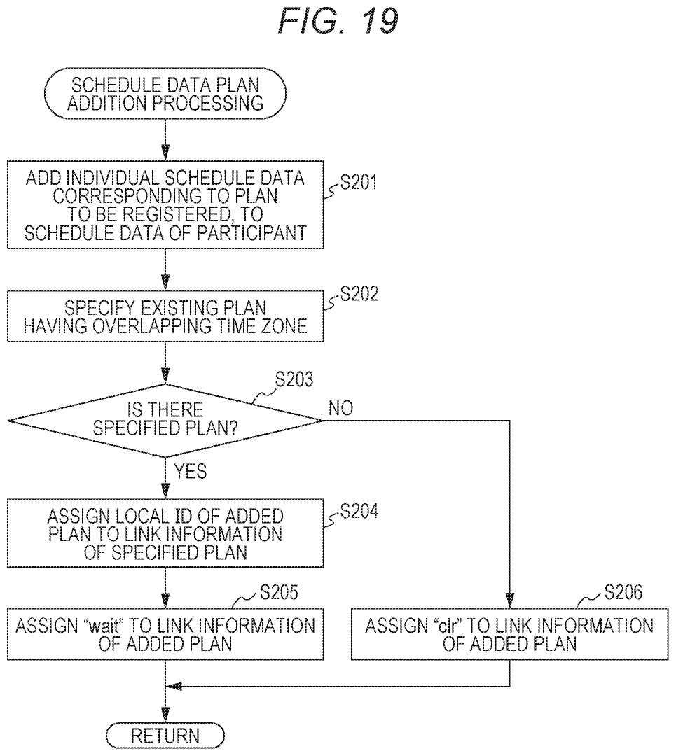

FIG. 19 is a flowchart illustrating a control procedure, executed by the CPU 11, of the schedule data plan addition processing.

When the plan addition processing to the schedule data is called, the CPU 11 adds the individual schedule data 132b corresponding to the plan to be registered, to the schedule data 132a of the user designated as a participant (step S201). That is, the CPU 11 newly adds the individual schedule data 132b including a plan ID of the plan to be added, to the schedule data 132a.

In the schedule data 132a, the CPU 11 specifies an existing plan having a time zone overlapping with the plan of the added individual schedule data 132b (step S202). In a case where a plan having an overlapping time zone has been specified (“YES” in step S203), the CPU 11 assigns a local ID of the individual schedule data 132b added in step S201 to the link information of the individual schedule data 132b related to the specified plan (step S204). Further, the CPU 11 assigns “wait” to the link information of the individual schedule data 132b added in step S201 (step S205).

In contrast, in a case where an existing plan with overlapping time zones has not been specified in the processing of step S203 (“NO” in step S203), the CPU 11 assigns “clr” to the link information of the individual schedule data 132b added in step S201 (step S206).

After completion of the processing of step S205 or step S206, the CPU 11 finishes the schedule data plan addition processing and returns the processing to the new plan registration processing.

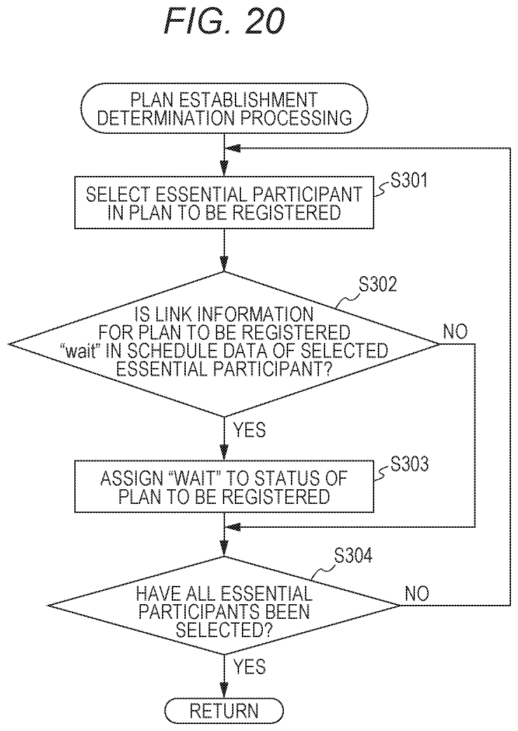

FIG. 20 is a flowchart illustrating a control procedure, executed by the CPU 11, of plan establishment determination processing.

When the plan establishment determination processing is started, the CPU 11 selects one user designated as an essential participant in the plan to be registered (step S301), and determines whether the link information of the individual schedule data 132b related to the plan to be registered is set to “wait” in the schedule data 132a of the essential participant (step S302).

In a case where it is determined that the link information of the individual schedule data 132b related to the plan to be registered is set to “wait” (“YES” in step S302), the CPU 11 assigns “WAIT” to the status of the individual plan data 131a related to the plan to be registered so as to perform provisional registration for the plan (step S303).

In a case where the processing of step S303 is completed, or where it is determined in the processing of step S302 that the link information of the individual schedule data 132b of the essential participant related to the plan to be registered is not set to “wait” (NO in step S302), the CPU 11 determines whether all of the essential participants in the plan have been selected (step S304). In a case where it is determined that there are unselected essential participants (“NO” in step S304), the CPU 11 returns the processing to step S301.

With execution of loop processing from step S301 to step S303 for each of essential participants, the status of the individual plan data 131a will be set to “WAIT” in a case where there is a prospect of non-participation of one of essential participants (that is, it is determined that the establishment conditions for the plan are not satisfied, and then, provisional registration is performed). In a case where there is no prospect of non-participation of any of essential participants, the status of the individual plan data 131a will be maintained to be “OK” (that is, it is determined that the establishment conditions for the plan are satisfied, and then, the finalized registration is performed).

In a case where it is determined that all the required essential participants have been selected (“YES” in step S304), the CPU 11 finishes the plan establishment determination processing and returns the processing to the new plan registration processing.

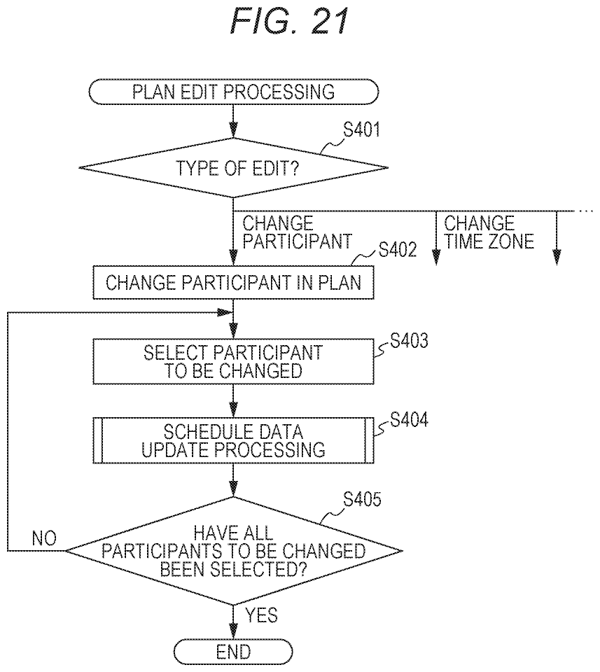

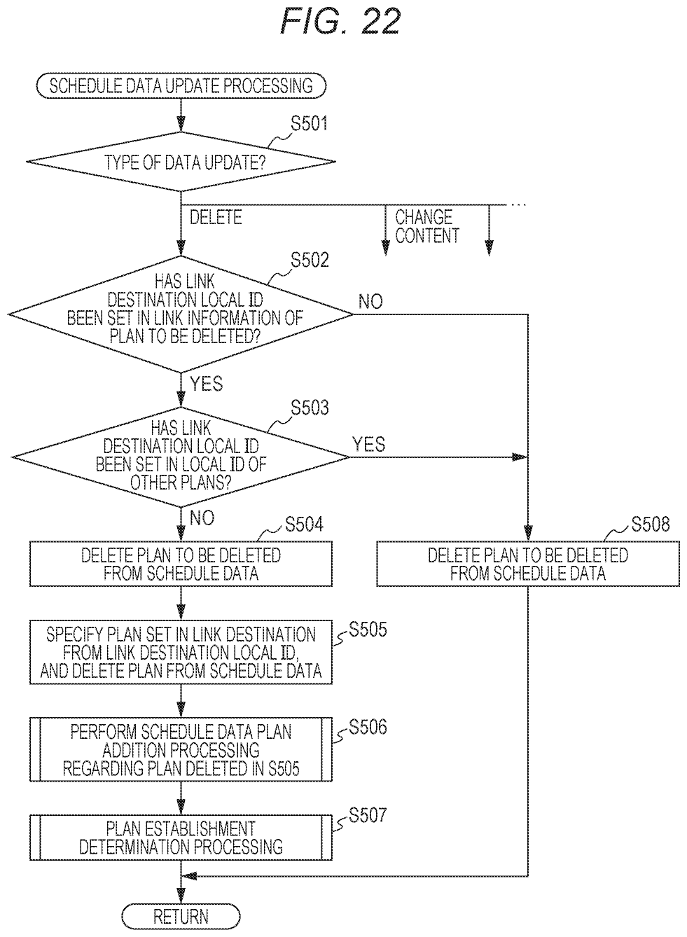

FIG. 21 is a flowchart illustrating a control procedure by the CPU 11 of the plan edit processing.

The plan edit processing is started in a case where predetermined input operation for editing a plan has been performed by a user on the application program 231 in any of the terminal devices 2 and information related to the editing of the plan has been transmitted from the terminal device 2 and received by the schedule management apparatus 1. The plan edit includes various modes such as changing a participant, changing a time zone, and deleting a plan, and plan edit processing is defined for each of these mode. However, plan edit will be described here using an example of changing a participant.

When the plan edit processing is started, the CPU 11 determines the type of edit for a plan (step S401). When it is determined that the type of edit of the plan is a participant change, the CPU 11 changes the setting of a participant in the individual plan data 131a (step S402).

Next, the CPU 11 selects one user who is a participant to be changed (step S403), and executes schedule data update processing described below (step S404).

The CPU 11 determines whether all the participants to be changed have been selected (step S405). In a case where it is determined that there is an unselected participant to be changed (“NO” in step S405), the CPU 11 returns the processing to step S403.

In a case where it is determined that all participants to be changed have been selected (“YES” in step S405), the CPU 11 finishes the plan edit processing.

FIG. 22 is a flowchart illustrating a control procedure, executed by the CPU 11, of the schedule data update processing. There are various modes of updating the schedule data 132a, such as deletion and content change, and schedule data update processing is defined for each of the modes. Here, the deletion of the plan (individual schedule data 132b) will be taken as an example for description.

When the schedule data update processing is called, the CPU 11 determines the type of update of the schedule data 132a (step S501). In a case where it is determined that the type of data update is deletion of the individual schedule data 132b related to the plan, the CPU 11 determines whether the link destination local ID is set in the link information of the individual schedule data 132b related to the plan to be deleted (step S502). In a case where it is determined that the link destination local ID is set (“YES” in step S502), the CPU 11 determines whether the set link destination local ID has been also set as the link destination local ID in the link information of any other individual schedule data 132b (step S503).

In a case where it is determined that the link destination local ID of the plan to be deleted is not set in the link information of the other individual schedule data 132b (“NO” in step S503), the CPU 11 deletes the individual schedule data 132b related to the plan to be deleted, from the schedule data 132a (step S504).

Next, the CPU 11 performs processing of step S505 to step S507 in order to update the link information in accordance with the content of the updated schedule data 132a for plan set in the link destination local ID of the deleted plan.

That is, the CPU 11 first specifies the plan set in the link destination local ID of the deleted plan, and tentatively deletes the individual schedule data 132b related to the plan from the schedule data 132a (step S505). On the basis of this, the CPU 11 executes, for the plan deleted in step S505, the “schedule data plan addition processing” in FIG. 19 to add the individual schedule data 132b (step S506). Subsequently, the CPU 11 executes “plan establishment determination processing” of FIG. 20 and determines again establishment conditions for each of the plans (step S507).

Meanwhile, in a case where it is determined in step S502 that the link destination local ID is not set in the link information of the individual schedule data 132b related to the plan to be deleted (“NO” in step S502), or in a case where it is determined in step S503 that the link destination local ID of a plan to be deleted is also set in the link information of any other individual schedule data 132b (“YES” in step S503), the CPU 11 simply deletes the individual schedule data 132b related to the plan to be deleted, from the schedule data 132a (step S508). This is because deleting the individual schedule data 132b to be deleted would not affect other individual schedule data 132b even when the link destination local ID is not set in the individual schedule data 132b to be deleted or when the link destination local ID of the individual schedule data 132b to be deleted is also set in the link information of the other individual schedule data 132b.

After completion of the processing of step S507 or step S508, the CPU 11 finishes the schedule data update processing and returns the processing to the plan edit processing.

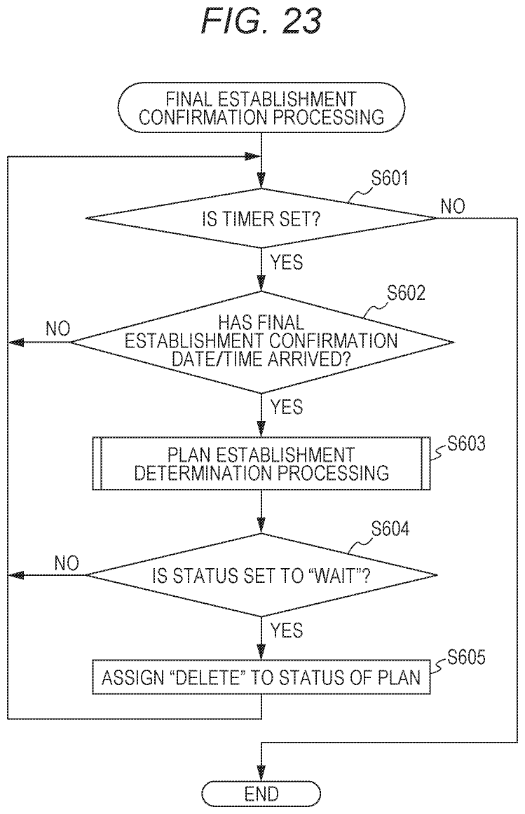

FIG. 23 is a flowchart illustrating a control procedure, executed by the CPU 11, of the final establishment confirmation processing.

The final establishment confirmation processing is executed in parallel with the other processing described above.

When the final establishment confirmation processing is started, the CPU 11 determines whether the timer is set in the timer management data 133, that is, whether there is a plan for which the final establishment confirmation date/time is set (step S601).

When it is determined that the timer is set (“YES” in step S601), the CPU 11 determines whether the final establishment confirmation date/time related to the timer setting has arrived (step S602). In a case where it is determined that the final establishment confirmation date/time has arrived (“YES” in step S602), the CPU 11 executes the plan establishment determination processing of FIG. 20 for the individual plan data 131a related to the plan for which the timer is set (step S603). After execution of the plan establishment determination processing, the CPU 11 determines whether the status is set to “WAIT” (step S604). In a case where it is determined that the status is set to “WAIT” (“YES” in step S604), the CPU 11 assigns “DELETE” to the status (step S605) and returns the processing to step S601.

In a case where it is determined in step S602 that the final establishment confirmation date/time has not arrived (“NO” in step S602), and where it is determined in step S604 that the status is not set to “WAIT” (“NO” in step S604), the CPU 11 returns the processing to step S601.

In a case where it is determined in step S601 that there is no timer setting, that is, where there is no timer setting from the beginning, or determined that the processing in steps S602 to S605 has been completed for all timer settings (“NO” in step S601), the CPU 11 finishes the final establishment confirmation processing.

As described above, the schedule management apparatus 1 as a plan registration apparatus (information processing apparatus) according to the above embodiment includes the CPU 11, in which the CPU 11 registers a plan to the plan database 131 as the individual plan data 131a on the basis of input information representing the plan, including settings related to participants selected from a plurality of users to be managed, time zones, and establishment conditions. At registration of plans to the plan database 131, the CPU 11 performs finalized registration as an established plan in a case where establishment conditions for the plan are satisfied. The CPU 11 performs provisional registration as a provisional plan before establishment in a case where the establishment conditions of the plan are not satisfied. In a case where establishment conditions for the plan are satisfied after execution of the provisional registration of the plan, the CPU cancels the provisional registration and performs finalized registration for the plan (plan registration means and plan registration processing).

In the actual operation of the schedule management system 100, the registration of the plan might be performed for the purpose of temporarily reserving the participant's schedule in a state where implementation of the plan is not yet determined, and such a plan is often canceled later. Adjusting the plan having time zone overlapping with the plan highly probable to be cancelled in this manner in registration of the plan as in the conventional technology, the processing related to the adjustment would often be wasted. In other words, there might be a case where a time zone change originally unnecessary for adjustment of overlapping plans is performed, or where a plan that can be held afterwards is inadvertently deleted.

In contrast, according to the above configuration of the present embodiment, in a case where establishment conditions of the plan to be newly registered is not satisfied, provisional registration will be performed while maintaining the setting of the plan, and then, in a case where the establishment conditions are satisfied afterwards, it is possible to perform finalized registration with the original setting. This makes it possible to adjust the plan more flexibly while avoiding such unnecessary adjustment as above. As a result, even in a case where a plan does not satisfy establishment conditions at registration of the plan, the user can adjust the plan without taking time to adjust plans to be registered, existing time zones and attendees, or wait for cancellation of the existing plan and re-register the plan. Therefore, user convenience can be improved.

Furthermore, the CPU 11 generates and updates, for each of a plurality of users, the schedule data 132a used for managing the user's schedule. In a case where a plan is to be registered in the plan database 131, the CPU 11 adds the plan as the individual schedule data 132b to the schedule data 132a related to the participants of the plan out of the plurality of users (schedule information processing means and schedule information management processing). The establishment conditions relate to the participation status of the participant with respect to the plan, and the CPU 11 determines whether the establishment conditions are satisfied on the basis of the schedule data 132a with additional plans, related to the participants in the plan (plan registration means and plan registration processing). According to this, the plan registered to the plan database 131 is reflected, by addition of the plan, to the schedule data 132a, making it possible to simply manage the schedule of each of the users by the schedule data 132a. Furthermore, by referring to the schedule data 132a, it is possible to easily determine the establishment conditions related to the user participation status.

Furthermore, the CPU 11 adds a plan ID for associating the schedule data 132a with a plan registered in the plan database 131 to the schedule data 132a, thereby adding the plan to the schedule data 132a (schedule information processing means and schedule information management processing). According to this, it is possible to efficiently use the storage capacity while suppressing wasteful registration of duplicate data in the plan database 131 and the schedule database 132.

Furthermore, in a case where the time zone of the first plan overlaps with at least a part of the time zone of an existing second plan when the CPU 11 adds a first plan to the schedule data 132a related to one user, the CPU 11 sets, in the schedule data 132a, a link destination local ID to the link information of the second plan to associate the first plan with the second plan. Moreover, the CPU 11 sets the link information of the first plan to “wait” to set the first plan as a plan in a waiting state (schedule information processing means and schedule information management processing). In registration of the plan to the plan database 131, the CPU 11 determines whether the establishment conditions are satisfied on the basis of whether the link information is set to “wait” in the schedule data 132a related to the participants in the plan (plan registration means and plan registration processing). According to this, by referring to the link information of the individual schedule data 132b, it is possible to easily determine for which plan each of the users has a prospect of non-participation.

In addition, it is possible to easily specify which other plan affects the prospect of non-participation. Accordingly, with reference to the individual schedule data 132b, it is possible to simply and surely determine the establishment conditions for the plan. In addition, the influence of the change of the schedule on each of users on other plans can be easily specified, making it possible to easily reconfirm the establishment conditions after the schedule change.

The establishment conditions include participation of one or more specific essential participants out of the participants. The CPU 11 determines non-satisfaction of establishment conditions in a case where link information is set to “wait” in the schedule data 132a related to one of the users set as an essential participant at plan registration to the plan database 131, and then performs provisional registration for the plan (plan registration means and plan registration processing). This makes it possible to perform flexible schedule management so as to make the attendance of a specific key person to be an establishment condition for the plan. In addition, such a key person is often designated as a participant in a large number of plans for the purpose of temporarily reserving the plans, and this would naturally cause frequent schedule settings and cancellations. Fortunately, however, according to the method in the present embodiment of first performing provisional registration and then performing determination of establishment conditions later, it is possible to perform finalized registration for the provisionally registered subsequent plan to achieve establishment of the plan with minimum necessary processing in accordance with the cancellation of the existing plan, or the like. Accordingly, even when there is an existing plan having overlapping time zone in schedules of essential participants at registration of plans, the user can adjust the plan without taking time to adjust the time zone of the plan or adjust the plans of the essential participant. Therefore, user convenience can be improved.

Furthermore, in a case where deletion or setting change of a plan in the plan database 131 has cancelled overlapping of the time zone of the first plan with the time zone of another plan, or the second plan has been deleted from the schedule data 132a related to one user, the CPU 11 changes the link information regarding the first plan from “wait” to “clr” to cancel the setting of the waiting state (schedule information processing means and schedule information management processing). In a case where the setting of the waiting state for the plan has been cancelled in the schedule data 132a related to all users who are essential participants in the plan for which provisional registration has been performed, the CPU 11 determines that the establishment conditions are satisfied, then, cancels provisional registration and performs finalized registration for the plan (plan registration means and plan registration processing). With this configuration, it is possible to perform, with simple processing, finalized registration for the subsequent plans for which provisional registration has been performed, in accordance with the change or deletion of the plan on the key person in the existing plan.

Moreover, a plan includes a final establishment confirmation time as a setting related to a provisional registration acceptable period in which provisional registration can be maintained. In a case where the establishment conditions are not satisfied at a point of arrival of the final establishment confirmation time of the plan for which provisional registration has performed, the CPU 11 performs predetermined non-establishment processing as a non-established plan (plan registration means and plan registration processing) on the plan in the plan database 131. The CPU 11 then performs exclusion processing for excluding the plan for which non-establishment processing has been performed in the schedule data 132a, from the schedule (schedule information processing means and schedule information management processing). There can be a problem that shifting to the finalized registration immediately before the start time of a plan to finalize execution of the plan would cause insufficient notification to the participants, leading to confusion. With the above-described configuration, however, the occurrence of problems can be suppressed by a simple method.

Furthermore, the CPU 11 causes the display unit 25 to display the schedule board 30 indicating the user's schedule in a manner that can distinguish between the plans for which provisional registration has been performed and the plans for which finalized registration has been performed on the basis of the plan database 131 and the schedule data 132a (presentation means and presentation processing). With this configuration, it is possible to clearly present the schedule for the users.

Furthermore, the CPU 11 causes the display unit 25 to display the schedule board 31 that displays, in a comparable manner, the schedules of two or more participants in a plan for which provisional registration or finalized registration has been performed, on the basis of the plan database 131 and the schedule data 132a. On the schedule board 31, the CPU 11 controls to display the plan for which provisional registration has been performed out of the plans included in the schedule of the two or more participants, in the first mode. In a case where the establishment conditions for the plan for which provisional registration has been performed are satisfied, the CPU 11 controls to display, on the schedule board 31, the plan in a second mode different from the first mode, indicating that the finalized registration has been performed (display control means and display control processing). With this processing, it is possible to perform schedule adjustment for shifting the plan from provisional registration to finalized registration in a method easy to grasp visually and intuitively. That is, with the display of the schedules of two or more users in comparison, the user can visually and intuitively grasp, with ease, schedule adjustment (for example, an adjustment to find a space for the plan for a key person) necessary to shift a plan under provisional registration to a plan under finalized registration. Accordingly, it is possible to easily and flexibly adjust the schedule so as to satisfy the establishment conditions for the plan for which provisional registration has been performed while maintaining the setting of plan for which the provisional registration has been performed.

Furthermore, the schedule management apparatus 1 as the plan registration apparatus (information processing apparatus) of the above embodiment includes the CPU 11. The CPU 11 causes the display unit 25 to display the schedule board 31 that displays the schedules of two or more participants in a plan in a comparable manner on the basis of input information indicating the plan, including setting related to participants selected from a plurality of users to be managed, time zones, and establishment conditions. The CPU 11 controls to display, on the schedule board 31, a plan that does not satisfy the establishment conditions out of the plans included in the schedule of two or more participants, in a first mode indicating that provisional registration has been made for the plan as a provisional plan before establishment. In a case where the establishment conditions for the plan for which provisional registration has been performed are satisfied, the CPU 11 controls to display, on the schedule board 31, the plan in a second mode different from the first mode, indicating that the finalized registration has been made for the plan as an established plan (display control means and display control processing). With this processing, it is possible to perform schedule adjustment for shifting the plan from provisional registration to finalized registration in a method easy to grasp visually and intuitively. That is, with the display of the schedules of two or more users in comparison, the user can visually and intuitively grasp, with ease, schedule adjustment (for example, an adjustment to find a space for the plan for a key person) necessary to shift a plan under provisional registration to a plan under finalized registration. Accordingly, it is possible to easily and flexibly adjust the schedule so as to satisfy the establishment conditions for the plan for which provisional registration has been performed while maintaining the setting of plan for which the provisional registration has been performed.

Furthermore, a plan registration method executed on the schedule management apparatus 1 according to the above embodiment includes a plan registration step of registering a plan to the plan database 131 as the individual plan data 131a on the basis of input information indicating the plan, including settings related to participants selected from a plurality of users to be managed, time zones, and establishment conditions. At registration of plans to the plan database 131, the plan registration step performs finalized registration as an established plan in a case where establishment conditions for the plan are satisfied. The plan registration step performs provisional registration as a provisional plan before establishment in a case where the establishment conditions of the plan are not satisfied. In a case where establishment conditions for the plan are satisfied after execution of the provisional registration of the plan, the step cancels the provisional registration and performs finalized registration for the plan. With execution of such a plan registration method in the schedule management apparatus 1, it is possible to adjust plans more flexibly.

Furthermore, a schedule management program 134 according to the above embodiment causes the CPU 11 as a computer provided on the schedule management apparatus 1 to function as a plan registration means that registers a plan to the plan database 131 as the individual plan data 131a on the basis of input information indicating the plan, including settings related to participants selected from a plurality of users to be managed, time zones, and establishment conditions. At registration of plans to the plan database 131, the plan registration means performs finalized registration as an established plan in a case where establishment conditions for the plan are satisfied, and the plan registration means performs provisional registration as a provisional plan before establishment in a case where the establishment conditions of the plan are not satisfied. In a case where establishment conditions for the plan are satisfied after execution of the provisional registration of the plan, the plan registration means cancels the provisional registration and performs finalized registration for the plan. Causing the schedule management apparatus 1 to operate by such a schedule management program 134 makes it possible to adjust plans more flexibly.

Furthermore, the schedule management program 134 according to the above embodiment causes the CPU 11 as a computer provided on the schedule management apparatus 1 to function as a display control means that causes the display unit 25 to display the schedule board 31 that displays the schedules of two or more participants in a plan in a comparable manner on the basis of input information indicating the plan, including settings related to participants selected from a plurality of users to be managed, time zones, and establishment conditions. The display control means controls to display, on the schedule board 31, a plan that does not satisfy the establishment conditions out of the plans included in the schedule of two or more participants, in a first mode indicating that provisional registration has been performed for the plan as a provisional plan before establishment. In a case where the establishment conditions for the plan for which provisional registration has been performed are satisfied, the display control means controls to display, on the schedule board 31, the plan in a second mode different from the first mode, indicating that the finalized registration has been performed for the plan as an established plan. Causing the schedule management apparatus 1 to operate by such a schedule management program 134 makes it possible to adjust plans more easily and flexibly.

The above description discloses an example in which the HDD and the SSD of the storage unit 13 are used as the computer-readable medium for the program according to the present invention, but the present invention is not limited to this example. Other computer-readable media that are applicable include portable recording media such as flash memory and CD-ROM. Furthermore, a carrier wave is also applicable to the present invention as a medium for providing data of a program according to the present invention via a communication line. Description in the above embodiment is an example of the plan registration apparatus, the plan registration method, and the recording medium according to the present invention, and the present invention is not limited to this.

For example, although the above embodiment has been described using an example in which the participation of an essential participant is an establishment condition for a plan, the present invention is not limited to this. Other examples of the establishment conditions for plans include conditions related to participation status of participants, such as participation of a predetermined number of participants among a plurality of specific users (for example, users belonging to a specific department) or the number of participants in the plan. In addition to this, requirements other than the participation status of the participants, such as availability of a desired meeting room, may be set as the establishment condition.

Furthermore, the plan managed by the schedule management system 100 is not limited to a meeting, and the present invention may be applied to events such as travel and dining.

Moreover, although the above embodiment has been described using an example of managing the user's schedule of the schedule management system 100, the plurality of persons to be managed for a plan is not restricted to the user of the schedule management system 100. For example, the plan of persons other than the user of the schedule management system 100 may be managed in accordance with input operation of a user who is a manager of the persons.

In addition, the method of presenting information related to the schedule to the user is not limited to the display of the schedule board 30 on the display unit 25. It is allowable to use other method such as transmission of an email, transmission of a message on a message application, notification using voice, or addition to a to-do-list on a task management application to present information related to the schedule.

The above embodiment has been described using an exemplary mode in which information related to the schedule managed on the schedule management apparatus 1 is transmitted to the terminal device 2 and the user confirms the schedule on the terminal device 2. The present invention is not limited to this mode, and may incorporate the functions of the schedule management apparatus 1 according to the above embodiment into the terminal device 2 used by the user. In this case, the terminal device 2 constitutes the information processing apparatus of the present invention.

The detailed configuration and detailed operation of individual components of the schedule management apparatus 1 as a plan registration apparatus (information processing apparatus) in the above embodiment can be modified as appropriate without departing from the spirit of the present invention.

Regarding the embodiments of the present invention that have been described, the scope of the present invention is not limited to the above-described embodiments, but includes the scope of the invention described in the claims and the equivalents thereof.

What is claimed is:

1. A plan registration apparatus comprising
a processor configured to execute
plan registration processing of registering a plan to predetermined plan information on the basis of input information representing the plan, including settings related to participants selected from a plurality of persons to be managed, time zones, and establishment conditions,
wherein the plan registration processing
performs, at registration of plans to the plan information, finalized registration as an established plan in a case where the establishment conditions for the plan are satisfied, and performs provisional registration as a provisional plan before establishment in a case where the establishment conditions of the plan are not satisfied, and
cancels the provisional registration and performs the finalized registration for the plan in a case where the establishment conditions for the plan are satisfied after execution of the provisional registration of the plan.

2. The plan registration apparatus according to claim 1, wherein the processor is configured to:
execute, for each of the plurality of persons, schedule information management processing of generating and updating schedule information used for managing the schedule of the person; and
add the plan to the schedule information related to the participant in the plan out of the plurality of persons in a case where the plan is registered by the plan registration processing in the schedule information management processing,
the establishment condition relates to a participation status of the participant in the plan, and
the plan registration processing determines whether the establishment condition is satisfied on the basis of the schedule information to which the plan has been added, which is related to the participant in the plan.

3. The plan registration apparatus according to claim 2, wherein the processor
attaches, in the schedule information management processing, information for associating the schedule information with the plan registered in the plan information, to the schedule information, and thereby adds the plan to the schedule information.

4. The plan registration apparatus according to claim 2,
wherein, in a case where a time zone of a first plan overlaps with at least a part of a time zone of an existing second plan when the first plan is to be added to the schedule information related to one person in the schedule information management processing, the processor sets the first plan associated with the second plan in the schedule information, as a plan in a waiting state for which there is a prospect of non-participation of the one person, and
the processor determines, in the plan registration processing, whether the establishment condition is satisfied on the basis of whether the plan has been set as the waiting state in the schedule information related to the participant in the plan at registration of the plan.

5. The plan registration apparatus according to claim 2,
wherein, in a case where a time zone of a first plan overlaps with at least a part of a time zone of an existing second plan when the first plan is to be added to the schedule information related to one person in the schedule information management processing, the processor is configured to set the first plan associated with the second plan in the schedule information, as a plan in a waiting state for which there is a prospect of non-participation of the one person
the establishment condition is participation of one, or two or more specific persons out of the participants, and
in a case where the plan is set to the waiting state in the schedule information related to any of the specific persons as a target of the establishment condition of the plan at registration of the plan in the plan registration processing, it is determined that the establishment condition is not satisfied, and the provisional registration is performed for the plan.

6. The plan registration apparatus according to claim 5, wherein the processor
cancels the setting of the waiting state for the first plan, in the schedule information management processing, in a case where the time zone of the first plan no longer overlaps with the time zone of the other plan due to deletion or a change of the plan in the plan information, or where the second plan has been deleted from the schedule information related to the one person, and
determines, in the plan registration processing, that the establishment condition is to be satisfied, then cancels the provisional registration and performs finalized registration for the plan in a case where the setting of the waiting state has been canceled for the plan in the schedule information related to all the specific persons being targets of the establishment conditions for the plan for which the provisional registration has been performed.

7. The plan registration apparatus according to claim 2,
wherein the plan includes a setting related to a provisional registration acceptable period in which the provisional registration can be maintained, and
the processor
performs, in the plan registration processing, predetermined non-establishment processing as a non-established plan for the plan in the plan information in a case where the establishment condition is not satisfied at a point of completion of the provisional registration acceptable period of the plan under the provisional registration, and
performs, in the schedule information management processing, exclusion processing of excluding the plan for which the non-establishment processing has been performed in the schedule information, from the schedule.

8. The plan registration apparatus according to claim 2, wherein the processor
executes presentation processing of presenting information related to the schedule of persons to a user in a mode that allows distinction between the plan for which the provisional registration has been performed and the plan for which the finalized registration has been performed, on the basis of the plan information and the schedule information.

9. The plan registration apparatus according to claim 2, wherein the processor
executes display control processing of causing a display unit to display a schedule screen on which schedules of two or more participants in the plan for which the provisional registration or the finalized registration has been performed are displayed in a comparable manner on the basis of the plan information and the schedule information, and
the processor controls to display, in the display control processing,
the plan for which the provisional registration has been performed out of the plans included in the schedules of the two or more participants in a first mode on the schedule screen, and
the plan, on the schedule screen, in a second mode different from the first mode, indicating that the finalized registration has been performed, in a case where the establishment condition for the plan for which the provisional registration has been performed is satisfied.

10. A plan registration method comprising
a plan registration step of registering a plan to predetermined plan information on the basis of input information representing the plan, including settings related to participants selected from a plurality of persons to be managed, time zones, and establishment conditions,
wherein the plan registration step
performs, at registration of plans to the plan information, finalized registration as an established plan in a case where the establishment conditions for the plan are satisfied, and performs provisional registration as a provisional plan before establishment in a case where the establishment conditions of the plan are not satisfied, and
cancels the provisional registration and performs finalized registration for the plan in a case where the establishment conditions for the plan are satisfied after execution of the provisional registration of the plan.

11. A non-transitory computer-readable recording medium for recording a program executable by a processor of a plan registration apparatus,
wherein the program causes the processor to execute plan registration processing of registering a plan to predetermined plan information on the basis of input information representing the plan, including settings related to participants selected from a plurality of persons to be managed, time zones, and establishment conditions, and
the plan registration processing
performs, at registration of plans to the plan information, finalized registration as an established plan in a case where the establishment conditions for the plan are satisfied, and performs provisional registration as a provisional plan before establishment in a case where the establishment conditions of the plan are not satisfied, and
cancels the provisional registration and performs finalized registration for the plan in a case where the establishment conditions for the plan are satisfied after execution of the provisional registration of the plan.
